(19) United States
(12) Patent Application Publication
(10) Pub. No.: US 2015/0353745 A1
(43) Pub. Date: Dec. 10, 2015

(54) DYE BLOCKING PRINTING INK SYSTEM FOR PRINTING ON POLYESTER BLENDED FABRICS

(71) Applicant: FUJIFILM SERICOL INDIA PVT. LTD., Shirur (IN)

(72) Inventors: Prasanna Raghav Rao MOTUPALLI, Telengana (IN); Narendra Koteswara Rao KAMMILI, Maharashtra (IN)

(21) Appl. No.: 14/576,726

(22) Filed: Dec. 19, 2014

(30) Foreign Application Priority Data
Jun. 10, 2014 (IN) 1899/MUM/2014

(51) Int. Cl. C09D 11/03; C09D 11/102; C09D 11/104; C09D 11/107

(52) U.S. Cl. CPC C09D 11/03; C09D 11/107; C09D 11/102; C09D 11/104; C08K 5/12

(57) ABSTRACT

The present disclosure relates to a dye blocking printing ink to stop dye migration from fabric to print, particularly in polyester blended and 100% polyester fabrics. The dye blocking printing ink of present disclosure comprises a resin devoid of vinyl chloride moiety, a plasticizer, a wetting agent and a formaldehyde free discharge agent. A process for printing fabrics using the dye blocking printing ink of the present disclosure is also disclosed.

### CROSSREFERENCE TO RELATED APPLICATIONS

This application claims priority from Indian Patent application no. 1899/MUM/2014 filed on Jun. 10, 2014, under 35 U.S.C. §119(a), entitled “Dye blocking printing ink system for printing on polyester blended fabrics”, which is incorporated herein by reference in its entirety.

### BACKGROUND OF THE INVENTION

1. Field of the Invention

The present disclosure relates to a printing ink, more particularly the present disclosure relates to a dye blocking printing ink system for printing on polyester based fabrics.

2. Description of the Background

Most textiles are colored with dyes which fix chemically to the textile fabrics; the coloring of the fabric is achieved without a noticeable change in the feel of the fabric itself. The chemical composition of the dye varies according to the fabric used—different dyes are required for different fabrics. Some fabrics contain a proportion of dye which is not sufficiently fixed to the fibres; this happens more frequently for blended fabrics. This residual dye is usually removed during the process of manufacturing the fabric; but if the residual dye is not removed completely, the action of water will wash out the unfixed dyes during washing. This can causes discoloration of the whole fabric. This phenomenon is called “Dye Bleeding”. Dye bleeding is normally seen with disperse dyes when used for dyeing polyester fabrics, although it may also be seen with fabric blends, such as polyester-cotton blends.

In case of polyester fabric printed with ink of the plastisol type, the unfixed disperse dyes in the fabric has a tendency to dissolve in the plasticizer of the plastisol inks with or without the need of external heat that is normally used to cure the printed area. This is called leaching of the dyes into the plasticizer or plastisol ink. This phenomenon of leaching is known as “Dye Migration” and can cause discoloration of the fabric as well as the printed image. The printed image will change from its original color, which is undesirable. The potential for dye migration is often not evident following printing and curing, and can occur subsequently anytime, within a few hours to a number of weeks.

The plastisol inks are normally heated (cured) at temperatures above 140° C. The dye leaching effect may be more severe resulting in fast discoloration of the printed image, when the plastisol printed fabrics are heated to this high temperature.

The disperse dyes also have a tendency to sublimate when heated, turning from a solid dye particle directly to a gas. This process can be accelerated by solvation due to the plasticizer.

Some of the methods used to prevent the problem of dye bleeding include plastisol inks that are based on low bleed formulations consisting of titanium dioxide (TiO₂) and activated carbon in their formulations. These formulations can control the dye bleeding completely in cotton fabrics and can minimize the dye bleeding to some extent in cotton—polyester blended fabrics. However, these formulations are not very effective when printing on polyester blended cotton fabrics and 100% polyester fabric.

Hybrids of plastisol inks and water-based discharge inks were used to stop dye bleeding. These inks contained a blend of polyvinyl chloride (PVC) and phthalate-containing plastisol and an activated water-based discharge ink. However, this type of ink is unstable and contains PVC and phthalates; also the activator for the discharge ink is based on Zinc Formaldehyde Sulphoxylate (ZFS). Even though the discharge agent is very efficient, the composition contains formaldehyde which is released during the discharge process, which is not desirable as it is detrimental to human health and the environment.

Therefore, there is a need for an effective dye blocking printing ink system, which will completely stop the dye migration from the fabric to the print and which is also environmentally friendly.

Some of the objects of the present disclosure, which at least one embodiment herein satisfies, are as follows:

It is an object of the present disclosure to provide a dye blocking printing ink system.

It is another object of the present disclosure to provide a dye blocking printing ink system that will stop dye migration from fabric to the print.

It is still another object of the present disclosure to provide a dye blocking printing ink system that will stop dye migration in polyester blended and 100% polyester fabrics.

It is yet another object of the present disclosure to provide a dye blocking printing ink system which is environment friendly.

Other objects and advantages of the present disclosure will be more apparent from the following description which is not intended to limit the scope of the present disclosure.

### SUMMARY OF THE INVENTION

The present disclosure provides a dye blocking printing ink comprising: a resin devoid of vinyl chloride moiety in an amount ranging from 15 to 45 wt %; a plasticizer in an amount ranging from 20 to 55 wt %; an organic wetting agent in an amount ranging from 5 to 35 wt %; and a formaldehyde free discharge agent in an amount ranging from 2 to 30 wt %.

In accordance with another aspect of the present disclosure, there is provided a process for printing a dyed fabric using the dye blocking printing ink of the present disclosure, said process comprising the following steps: applying at least two strokes of said dye blocking printing ink on said fabric and flash drying the print at a temperature ranging from 90 to 110° C. for a time period ranging from 2 to 6 seconds; optionally applying at least two strokes of a white ink over the said flash cured dye blocking printing ink and flash curing at a temperature ranging from 90 to 100° C. for a time period ranging from 2 to 6 seconds; and applying a final layer of color dye over said white ink with a color printing ink and curing the color print at a temperature ranging from 140 to 180° C. for a time period ranging from 60 to 120 seconds.

### DETAILED DESCRIPTION

The present invention envisages a dye blocking printing ink system, which when printed on polyester blended cotton fabric or 100% polyester fabric (a) bleaches the dye on the surface of the fabric with the discharge agents present in ink; and (b) forms a protective layer on top of the fabric with the additives present in the ink. This is printed in conjunction with a white overprinted on it, thus completely stopping any dye migration into the print.

In one aspect of the present disclosure, the dye blocking printing ink system includes the following steps:

1. Use of a resin devoid of vinyl chloride moiety—the dye blocking printing ink of the present disclosure is based on a resin devoid of vinyl chloride moiety and a phthalate free dye blocking discharge system. The phthalate free, non-solvating polymeric plasticizers and resins devoid of vinyl chloride moiety used in the system include acrylic resins, silicones, polyurethanes, polyesters, epoxies and the like.

In an exemplary embodiment of the present disclosure, acrylic resin is used for the preparation of the dye blocking printing ink system.

In an embodiment of the present disclosure the amount of the resin in the dye blocking printing ink ranges from 15 to 45 wt %, preferably from 20 to 35 wt %.

2. Use of plasticizers—plasticizers that have low solvating power in order to minimize the dye migration are preferred for the preparation of dye blocking printing ink system according to the present disclosure. The plasticizers of the present disclosure are polymeric plasticizers, which are large molecules and have low volatility, thereby, reducing the dissolution of the dye molecules that can occur when using more active plasticizers.

However, high solvating plasticizers including but not limited to Benzoflex 354 forms a tough film with the acrylic resin used in the present disclosure, which prevents the dye from dissolving and from migrating to the upper layer consisting of white ink film.

In an embodiment of the present disclosure, the plasticizer includes but is not limited to the group consisting of Benzoflex 354 (Eastman Chemical Company) and Hexamoll DINCH (BASF), Dioplex PLA (HallStar).

In an embodiment of the present disclosure the amount of the plasticizer in the dye blocking printing ink ranges from 20 to 55 wt %, preferably from 30 to 45 wt %.

3. Use of an organic wetting agent—the dye blocking printing ink of the present disclosure further comprises at least one wetting agent.

Any suitable wetting agent can be used, preferably the wetting agent in accordance with the present disclosure is an organic solvent selected from the group consisting of white spirit and mineral turpentine.

In an embodiment of the present disclosure the amount of the wetting agent in the dye blocking printing ink ranges from 5 to 35 wt %, preferably from 15 to 25 wt %.

4. Use of formaldehyde-free discharge agent—the discharge agent is capable of destroying the chromogenic system of the dyes under appropriate heating/curing conditions of fabric and partially bleaching the dye from the fabric. This process would turn the original fabric color to a much lighter color. The heating and curing conditions typically consists of infra-red flash curing or steam curing, immediately following the printing process. Available discharge agents are normally used only in the water based discharge ink system, which are mainly used for discharging dyes in 100% cotton fabrics. Conventionally, ZFS is used as a discharge agent, which releases formaldehyde during use.

Accordingly, the dye blocking printing ink of the present disclosure comprises a discharge agent, which is formaldehyde free.

The discharge/reducing agent of the present disclosure is represented by formula I below:

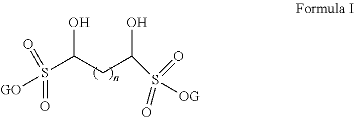

where:
G represents a group 1 metal; and n is 1-6.

The group 1 metal of the present disclosure can be at least one from a group consisting of sodium and potassium.

Optionally, the discharge agent may also have a metal salt and/or an amine.

In an embodiment of the present disclosure the metal salt is at least one selected from the group comprising sulfate, chloride, nitrate and acetate.

In an exemplary embodiment of the present disclosure the metal salt is zinc sulfate.

In another embodiment of the present disclosure the amine is at least one selected from the group comprising mono-ethanolamine, di-ethanolamine, tri-ethanolamine, mono-isopropanolamine and di-isopropanolamine.

In an embodiment of the present disclosure the amount of the discharge agent in the dye blocking orienting ink ranges from 2 to 30 wt %, preferably from 5 to 15 wt %.

Optionally, the dye blocking printing ink of the present disclosure comprises a dye absorbing extender. These dye absorbing extender have a very high surface area, which serves to absorb the residual dyes on the fabric after dyeing. The dye absorbing extender can be locked into the system with resin during the curing process, providing an impermeable surface for further printing with special white plastisol ink.

Non-limiting examples of the extender in accordance with the present disclosure include but is not limited to zeolite and activated carbon.

In an embodiment of the present disclosure the amount of the extender in the dye blocking printing ink ranges from 3 to 40 wt %, preferably from 5 to 20 wt %.

The printing ink of the present disclosure also comprises an extender powder to increase viscosity leading to improved hold-out on porous fabrics. The extender powder is at least one from the group consisting of fumed silica and hydrophilic silica.

In another embodiment of the present disclosure, a cross-linking agent is used to reduce the curing temperature. The cross-linking agent of the present disclosure can be aziridine.

The coloring agent in accordance with the present disclosure is selected from the group comprising TiO₂ of Rutile and Anatase pigment grade.

In accordance with another aspect of the present disclosure, there is provided a process for printing a dyed fabric using the dye blocking printing ink of the present disclosure.

Initially, a dye blocking base is prepared by mixing the dye blocking printing ink prepared in accordance with the present disclosure with an organic reducing agent such as but not limited to Sera Con P-ACT (DyStar) in a ratio of 100:10 to obtain a homogenous mixture. The obtained homogenous mixture has a shelf life of about 8 to 12 hours depending upon the storage temperature.

In the first step, the dye blocking base prepared in accordance with the present disclosure is applied on a fabric using a monofilament polyester mesh ranging from 43T to 55T. The discharge agent present in the dye blocking printing ink bleaches the dye on the surface of the fabric and forms a protective layer on top of the fabric. Two strokes of the dye blocking printing ink can be applied on the fabric. The print is then flash cured at a temperature ranging from 90 to 110° C. for about 4 seconds.

The dye blocking printing ink layer should not be over flash cured as it may result in the shrinking of the 100% polyester fabric.

In the next step, after the print is touch dry, optionally a second layer of white is applied on the fabric already printed with the dye blocking ink of the present disclosure. Two strokes of the white print are applied on the fabric using a monofilament polyester mesh ranging from 43T to 55T and flash cured at a temperature of 90 to 100° C. for about 4 seconds.

Once the white layer is touch dry, a final layer of color is applied monofilament polyester mesh ranging from 43T to 77T and cured at a temperature ranging from 140 to 180° C. for a time period ranging from 60 to 120 seconds.

Optionally, the color print can be applied directly to the dye blocking ink of the present disclosure without the application of the white print.

Typically, the dyed fabric is a dyed polyester, a dyed cellulose based fabric and a combination thereof.

The dye blocking printing ink system of the present disclosure can be used for printing fabrics by screen printing by manual/table/automatic machine printing.

The dye blocking printing ink system according to the present disclosure uses formaldehyde-free discharge agent, plasticizers with low solvating power, extender to absorb residual dye, and a white plastisol ink to be over printed on the dye blocker ink. The low bleed flash-cure white plastisol ink when over printed on the dye blocker ink, gives a white base for printing plastisol colors to create required images on the fabric.

The present disclosure is further described in the light of the following non-limiting examples which is set forth for illustration purpose only and not to be construed for limiting the scope of the disclosure.

### Example 1

### Preparation of Dye Blocking Ink (Formula 1)

The setup consisted of a stainless steel double jacketed pot having a provision of recirculating water at a temperature of 20° C. 29 g of Kane Ace 4944F (Kaneka, molecular weight: 700,000 g/mol), 41 g of Benzoflex 354 (Eastman Chemical Company), 8.5 g of Zinc Sulfate Heptahydrate and 5 g of Zeolite 13X was charged into the stainless steel double jacketed pot to obtain a pre-mixture. This pre-mixture was maintained at a temperature of 25° C. The pre-mixture was mixed in a Variable Frequency Drive Mixer (VFD) having a side scraper for 30 minutes at 500 rpm to obtain a mixture. The mixture was then milled in a triple roll mill at 20 kg/cm2 pressure of feed roll and discharge roll, until all the mill base passes through the mill to obtain a milled base. The milling process was repeated till a mill base of size <5 microns was obtained on a Hegman gauge. The milled base was again thoroughly mixed in the VFG mixer having a side scraper at 500 rpm for 30 minutes. 8 g of white spirit and 8 g of 2-Amino-2-Methyl-1-Propanol Solution (AMP-95) was charged to the mixed and milled base and again mixed in the VFD at 500 rpm for 40 minutes. Finally, 0.5 g of aerosil was charged to the mixture and the viscosity was adjusted to 40 poise.

### Example 2

### Preparation of Dye Blocking Ink (Formula 2)

The setup consisted of a stainless steel double jacketed pot having a provision of recirculating water at a temperature of 20° C. 31 g of LP-3207 (Dianal), 34.5 g of Dioplex PLA (Hallstar), 10 g of Hexamoll DINCH, 9 g of Zinc Sulfate Heptahydrate and 5 g of activated charcoal was charged into the stainless steel double jacketed pot to obtain a pre-mixture. This pre-mixture was maintained at a temperature of 25° C. The pre-mixture was mixed in a Variable Frequency Drive Mixer (VFD) having a side scraper for 30 minutes at 500 rpm to obtain a mixture. The mixture was then milled in a triple roll mill at 20 kg/cm2 pressure of feed roll and discharge roll, until all the mill base passes through the mill to obtain a milled base. The milling process was repeated till a mill base of size <5 microns was obtained on a Hegman gauge. The milled base was again thoroughly mixed in the VFG mixer having a side scraper at 500 rpm for 30 minutes. 8 g of white spirit and 2 g of 2-Amino-2-Methyl-1-Propanol Solution (AMP-95) was charged to the mixed and milled base and again mixed in the VFD at 500 rpm for 40 minutes. Finally, 0.5 g of aerosil was charged to the mixture and the viscosity was adjusted to 40 poise.

### Example 3

### Preparing the Dye Blocking Base

100 parts of the Formula 1 prepared in Example 1 was mixed thoroughly with 10 parts of Sera Con P-ACT (DyStar) using a spatula to obtain a homogenous mixture.

### Example 4

### Printing the Dye Blocking Ink on the Fabric

The dye blocking base prepared in Example 3 was printed on a 100% polyester fabric using a 43T mesh. Two strokes of the dye blocking base were applied on the fabric. The print was flash cured at a temperature of 110° C. for 4 seconds. After the print was touch dry, a second layer of YC.757 (Fujifilm, white) using a monofilament polyester mesh (43T mesh) was applied on the fabric already printed with the dye blocking base of Example 1. Two strokes of YC.757 were applied using a monofilament polyester mesh (43T mesh) and then flash cured at a temperature of 100° C. for 4 seconds. After the layer of YC.757 was touch dry, a final layer of YC.077 (Fujifilm, color) was applied using monofilament polyester mesh (77T mesh) and cured at a temperature of 160° C. for 90 seconds.

The fabrics after printing were subjected to washing (5 cycles) and heat treatment at 90° C. for 24 hours.

Wash Test of the printed fabrics
Wash Conditions

| Machine | Miele PW 6065 | |
|---|---|---|
| Load Weight | 2.0 | Kg |
| Wash Temperature | 60° | C. |
| Wash Program | Normal | |
| Time | 60 | minutes |
| Spin Speed | 1000 | rpm |

| | |
|---|---|
| Detergent | 30 g Persil Powder |
| Number of Wash and Dry Cycles | 5 |

Drying Conditions for the washed fabrics

| | |
|---|---|
| Machine Tumble Dry | 50 minutes |

Exhaust less than or equal to 70° C.

The comparative results of the L, a, b values of the dye blocking ink of the present disclosure, ‘As Such’ (the first reading taken after printing, without washing/heat treatment) values, after washing and heat treatment are illustrated in the Tables 1 to 6.

For the evaluations of the dye blocking ink the L values were considered. The standard taken here to compare the color variation was the color printed on the 100% white cotton. 100% white cotton was first printed with an YC.757 white layer and then a color layer was printed on the white layer. The L, a, b values of the color printed on white cotton was taken as a standard because it does not have a dye that will migrate to the top color, turning the color towards a darker shade.

The Tables 1 to 6 illustrate the L, a, b Values of different color dyes (YC.077, YC.021, YC.042, YC.134, YC.165, and YC.119) printed on 100% black polyester and 60:40 polyester:cotton blend, having a YC.757 white base. The readings were taken of ‘As Such’ prints. The values after it was subjected to heat test at 90° C. for 24 hours and values of prints after 5 wash test. These values are taken as standard for comparison. The values of ‘As Such’ prints on white garments are compared with ‘As Such’ prints on fabric printed with and without the dye blocker ink. The values of prints subjected to heat test are compared with fabric printed with and without the dye blocker ink. The values of prints subjected to wash test are compared with fabric printed with and without the dye blocker ink.

TABLE 1

| | | | W/O Dye Blocker | | | | Formula 1, YC.021 | |
|---|---|---|---|---|---|---|---|---|
| | | Garment | | | | | | |
| | | White | | | | | 100% Black Polyester | |
| | | taken as | 100% | | 60:40 | | Layer1: | |
| | | Standard | Black Polyester | | Polyester Blend | | Formula 1 | |
| | | Layer1: | Layer1: | | Layer1: | | Layer2: | |
| | | YC.757 | YC.757 | Difference as | YC.757 | Difference as | YC.757 | Difference as |
| | LABCH | Layer2: | Layer2: | compared to | Layer2: | compared to | Layer3: | compared to |
| | Values | YC.021 | YC.021 | Standard | YC.021 | Standard | YC.021 | Standard |
| AS Such | L | 96.57 | 59.03 | 037.54 | 73.17 | 23.4 | 95.66 | 0.910 |
| | A | −0.06 | 0.12 | −0.18 | −2.69 | 2.63 | −0.85 | 0.790 |
| | B | 0.98 | −7.69 | 8.67 | −3.2 | 4.18 | 0.48 | 0.500 |
| | C | 0.98 | 7.69 | −6.71 | 4.18 | −3.2 | 0.97 | 0.010 |
| | H | 93.44 | 270.89 | −177.45 | 229.92 | −136.48 | 150.65 | −57.210 |
| 24 hrs 90 | L | 96.69 | | | | | 94.46 | 2.23 |
| Deg C. | A | −0.18 | | | | | −1.2 | 1.02 |
| | B | 1.11 | | | | | 1.73 | −0.62 |
| | C | 1.13 | | | | | 2.1 | −0.97 |
| | H | 99.07 | | | | | 124.84 | −25.77 |
| After 5 | L | 94.71 | | | | | 90.39 | 4.32 |
| Wash @ | A | 0.2 | | | | | 0.27 | −0.07 |
| 60 | B | −0.15 | | | | | 0.07 | −0.22 |
| Deg C./60 | C | 0.24 | | | | | 0.27 | −0.03 |
| Minutes | H | 323.46 | | | | | 14.54 | 308.92 |

| | | Formula 1, YC.021 | | Formula 2, YC.021 | | | |
|---|---|---|---|---|---|---|---|
| | | Garment | | | | | |
| | | 60:40 Polyester Blend | | 100% Black Polyester | | 60:40 Polyester Blend | |
| | | Layer1: | | Layer1: | | Layer1: | |
| | | Formula 1 | | Formula 2 | | Formula 2 | |
| | | Layer2: | | Layer2: | | Layer2: | |
| | | YC.757 | Difference as | YC.757 | Difference as | YC.757 | Difference as |
| | LABCH | Layer3: | compared to | Layer3: | compared to | Layer3: | compared to |
| | Values | YC.021 | Standard | YC.021 | Standard | YC.021 | Standard |
| AS Such | L | 94.53 | 0.91 | 94.57 | 2 | 94.98 | 1.59 |
| | A | −0.97 | 0.79 | −0.79 | 0.73 | −0.77 | 0.71 |
| | B | 1.37 | 0.5 | −0.1 | 1.08 | 1.11 | −0.13 |
| | C | 1.68 | 0.01 | 0.79 | 0.19 | 1.35 | −0.37 |
| | H | 125.22 | −57.21 | 187.4 | −93.96 | 124.7 | −31.26 |
| 24 hrs 90 | L | 93.04 | 3.65 | 93.56 | 3.13 | 92.84 | 3.85 |
| Deg C. | A | −0.63 | 0.45 | −0.79 | 0.61 | 0.35 | −0.53 |
| | B | 5.29 | −4.18 | −0.24 | 1.35 | 5.96 | −4.85 |
| | C | 5.32 | −4.19 | 0.82 | 0.31 | 5.97 | −4.84 |
| | H | 96.82 | 2.25 | 197.2 | −98.13 | 93.35 | 5.72 |
| After 5 | L | 89.87 | 4.84 | 89.29 | 5.42 | 91.34 | 3.37 |
| Wash @ | A | −0.17 | 0.37 | 0.15 | 0.05 | −0.7 | 0.9 |
| 60 | B | 1.42 | −1.57 | −0.65 | 0.5 | 1.39 | −1.54 |
| Deg C./60 | C | 1.43 | −1.19 | 0.67 | −0.43 | 1.55 | −1.31 |
| Minutes | H | 96.7 | 226.76 | 283.8 | 39.66 | 116.69 | 206.77 |

TABLE 2

| | | | W/O Dye Blocker | | | | Formula 1, YC.042 | |
|---|---|---|---|---|---|---|---|---|
| | | Garment | | | | | | |
| | | White | | | | | 100% Black Polyester | |
| | | taken as | 100% | | 60:40 | | Layer1: | |
| | | Standard | Black Polyester | | Polyester Blend | | Formula 1 | |
| | | Layer1: | Layer1: | | Layer1: | | Layer2: | |
| | | YC.757 | YC.757 | Difference as | YC.757 | Difference as | YC.757 | Difference as |
| | LABCH | Layer2: | Layer2: | compared to | Layer2: | compared to | Layer3: | compared to |
| | Values | YC.042 | YC.042 | Standard | YC.042 | Standard | YC.042 | Standard |
| AS Such | L | 92.67 | 50.7 | 41.97 | 55.18 | 37.49 | 92.13 | 0.54 |
| | A | −12.1 | −8.08 | −4.02 | −12.72 | 0.62 | −15.13 | 3.03 |
| | B | 76.7 | 16.68 | 60.02 | 30.9 | 45.8 | 74.3 | 2.4 |
| | C | 77.65 | 18.54 | 59.11 | 33.42 | 44.23 | 75.83 | 1.82 |
| | H | 98.96 | 115.85 | −16.89 | 112.37 | −13.41 | 101.51 | −2.55 |
| 24 hrs 90 | L | 93.05 | | | | | 89.76 | 3.29 |
| Deg C. | A | −11.53 | | | | | −13.51 | 1.98 |
| | B | 74.48 | | | | | 70.58 | 3.9 |
| | C | 75.36 | | | | | 71.86 | 3.5 |
| | H | 98.8 | | | | | 100.83 | −2.03 |
| After 5 | L | 91.74 | | | | | 87.34 | 4.4 |
| Wash @ | A | −12.72 | | | | | −13.04 | 0.32 |
| 60 | B | 72.21 | | | | | 65.95 | 6.26 |
| Deg C./60 | C | 73.32 | | | | | 67.23 | 6.09 |
| Minutes | H | 99.99 | | | | | 101.18 | −1.19 |

| | | Formula 1, YC.042 | | Formula 2, YC.042 | | | |
|---|---|---|---|---|---|---|---|
| | | Garment | | | | | |
| | | 60:40 Polyester Blend | | 100% Black Polyester | | 60:40 Polyester Blend | |
| | | Layer1: | | Layer1: | | Layer1: | |
| | | Formula 1 | | Formula 2 | | Formula 2 | |
| | | Layer2: | | Layer2: | | Layer2: | |
| | | YC.757 | Difference as | YC.757 | Difference as | YC.757 | Difference as |
| | LABCH | Layer3: | compared to | Layer3: | compared to | Layer3: | compared to |
| | Values | YC.042 | Standard | YC.042 | Standard | YC.042 | Standard |
| AS Such | L | 90.88 | 1.79 | 91.57 | 1.1 | 90.02 | 2.65 |
| | A | −14.26 | 2.16 | −13.31 | 1.21 | −10.72 | −1.38 |
| | B | 70.76 | 5.94 | 74.54 | 2.16 | 71.37 | 5.33 |
| | C | 72.18 | 5.47 | 75.72 | 1.93 | 72.17 | 5.48 |
| | H | 101.4 | −2.44 | 100.12 | −1.16 | 98.54 | 0.42 |
| 24 hrs 90 | L | 89.11 | 3.94 | 90.8 | 2.25 | 88.78 | 4.27 |
| Deg C. | A | −12.25 | 0.72 | −13.26 | 1.73 | −10.24 | −1.29 |
| | B | 69.13 | 5.35 | 73.76 | 0.72 | 68.42 | 6.06 |
| | C | 70.2 | 5.16 | 74.94 | 0.42 | 69.18 | 6.18 |
| | H | 100.05 | −1.25 | 100.19 | −1.39 | 98.52 | 0.28 |
| After 5 | L | 83.91 | 7.83 | 88.29 | 3.45 | 87.31 | 4.43 |
| Wash @ | A | −12.44 | −0.28 | −12.36 | −0.36 | −11.39 | −1.33 |
| 60 | B | 63.44 | 8.77 | 67.6 | 4.61 | 66.85 | 5.36 |
| Deg C./60 | C | 64.65 | 8.67 | 68.72 | 4.6 | 67.81 | 5.51 |
| Minutes | H | 101.1 | −1.11 | 100.36 | −0.37 | 99.67 | 0.32 |

TABLE 3

| | | | W/O Dye Blocker | | | | Formula 1, YC.134 | |
|---|---|---|---|---|---|---|---|---|
| | | Garment | | | | | | |
| | | White | | | | | 100% Black Polyester | |
| | | taken as | 100% | | 60:40 | | Layer1: | |
| | | Standard | Black Polyester | | Polyester Blend | | Formula 1 | |
| | | Layer1: | Layer1: | | Layer1: | | Layer2: | |
| | | YC.757 | YC.757 | Difference as | YC.757 | Difference as | YC.757 | Difference as |
| | LABCH | Layer2: | Layer2: | compared to | Layer2: | compared to | Layer3: | compared to |
| | Values | YC.134 | YC.134 | Standard | YC.134 | Standard | YC.134 | Standard |
| AS Such | L | 47.14 | 31.6 | 15.54 | 32.04 | 15.10 | 46.94 | 0.20 |
| | A | 60.02 | 14.07 | 45.95 | 26.26 | 33.76 | 58.98 | 1.04 |
| | B | 32.95 | 9.14 | 23.81 | 15.98 | 16.97 | 33.03 | −0.08 |
| | C | 68.46 | 16.78 | 51.68 | 30.74 | 37.72 | 67.6 | 0.86 |
| | H | 28.77 | 33.03 | −4.26 | 31.32 | −2.55 | 29.25 | −0.48 |
| 24 hrs 90 | L | 46.97 | | | | | 45.79 | 1.18 |
| Deg C. | A | 58.24 | | | | | 54.37 | 3.87 |
| | B | 33.27 | | | | | 29.57 | 3.7 |
| | C | 67.07 | | | | | 61.89 | 5.18 |
| | H | 29.74 | | | | | 28.54 | 1.2 |
| After 5 | L | 46.98 | | | | | 46.16 | 0.82 |
| Wash @ | A | 55.84 | | | | | 53.79 | 2.05 |
| 60 | B | 32.2 | | | | | 30.75 | 1.45 |
| Deg C./60 | C | 64.45 | | | | | 61.96 | 2.49 |
| Minutes | H | 29.97 | | | | | 29.76 | 0.21 |

| | | Formula 1, YC.134 | | Formula 2, YC.134 | | | |
|---|---|---|---|---|---|---|---|
| | | Garment | | | | | |
| | | 60:40 Polyester Blend | | 100% Black Polyester | | 60:40 Polyester Blend | |
| | | Layer1: | | Layer1: | | Layer1: | |
| | | Formula 1 | | Formula 2 | | Formula 2 | |
| | | Layer2: | | Layer2: | | Layer2: | |
| | | YC.757 | Difference as | YC.757 | Difference as | YC.757 | Difference as |
| | LABCH | Layer3: | compared to | Layer3: | compared to | Layer3: | compared to |
| | Values | YC.134 | Standard | YC.134 | Standard | YC.134 | Standard |
| AS Such | L | 47.73 | −0.59 | 45.23 | 1.91 | 45.96 | 1.18 |
| | A | 58.18 | 1.84 | 56.59 | 3.43 | 58.08 | 1.94 |
| | B | 31.03 | 1.92 | 31.36 | 1.59 | 32.05 | 0.9 |
| | C | 65.94 | 2.52 | 64.7 | 3.76 | 66.33 | 2.13 |
| | H | 28.07 | 0.7 | 28.99 | −0.22 | 28.89 | −0.12 |
| 24 hrs 90 | L | 46.06 | 0.91 | 45.65 | 1.32 | 46.13 | 0.84 |
| Deg C. | A | 54.22 | 4.02 | 56.02 | 2.22 | 57.82 | 0.42 |
| | B | 29.38 | 3.89 | 30.58 | 2.69 | 32.08 | 1.19 |
| | C | 61.67 | 5.4 | 63.82 | 3.25 | 66.12 | 0.95 |
| | H | 28.45 | 1.29 | 28.63 | 1.11 | 29.02 | 0.72 |
| After 5 | L | 41.23 | 5.75 | 44.85 | 2.13 | 45.03 | 1.95 |
| Wash @ | A | 45.28 | 10.56 | 52.61 | 3.23 | 54.67 | 1.17 |
| 60 | B | 22.65 | 9.55 | 30.04 | 2.16 | 30.93 | 1.27 |
| Deg C./60 | C | 50.63 | 13.82 | 60.58 | 3.87 | 62.81 | 1.64 |
| Minutes | H | 26.57 | 3.4 | 29.73 | 0.24 | 29.5 | 0.47 |

TABLE 4

| | | | W/O Dye Blocker | | | | Formula 1, YC.165 | |
|---|---|---|---|---|---|---|---|---|
| | | Garment | | | | | | |
| | | White | | | | | 100% Black Polyester | |
| | | taken as | 100% Black | | 60:40 Polyester | | Layer1: | |
| | | Standard | Polyester | | Blend | | Formula 1 | |
| | | Layer1: | Layer1: | | Layer1: | | Layer2: | |
| | | YC.757 | YC.757 | Difference as | YC.757 | Difference as | YC.757 | Difference as |
| | LABCH | Layer2: | Layer2: | compared to | Layer2: | compared to | Layer3: | compared to |
| | Values | YC.165 | YC.165 | Standard | YC.165 | Standard | YC.165 | Standard |
| AS Such | L | 47.12 | 28.59 | 18.53 | 29.62 | 17.5 | 48.95 | −1.83 |
| | A | 60.17 | 12.94 | 47.23 | 25.94 | 34.23 | 61.42 | −1.25 |
| | B | −8.4 | −9.88 | 1.48 | −12.59 | 4.19 | −10.75 | 2.35 |
| | C | 60.76 | 16.28 | 44.48 | 28.83 | 31.93 | 62.36 | −1.6 |
| | H | 352.05 | 322.63 | 29.42 | 334.1 | 17.95 | 350.08 | 1.97 |
| 24 hrs 90 | L | 48.89 | | | | | 49.36 | −0.47 |
| Deg C. | A | 61.85 | | | | | 60.04 | 1.81 |
| | B | −10.05 | | | | | −11.35 | 1.3 |
| | C | 62.66 | | | | | 61.1 | 1.56 |
| | H | 350.77 | | | | | 349.3 | 1.47 |
| After 5 | L | 46.47 | | | | | 47.26 | −0.79 |
| Wash @ | A | 57.6 | | | | | 56.15 | 1.45 |
| 60 | B | −9.16 | | | | | −11.27 | 2.11 |
| Deg C./60 | C | 58.32 | | | | | 57.27 | 1.05 |
| Minutes | H | 350.96 | | | | | 348.65 | 2.31 |

| | | Formula 1, YC.165 | | Formula 2, YC.165 | | | |
|---|---|---|---|---|---|---|---|
| | | Garment | | | | | |
| | | 60:40 | | 100% Black | | 60:40 | |
| | | Polyester Blend | | Polyester | | Polyester Blend | |
| | | Layer1: | | Layer1: | | Layer1: | |
| | | Formula 1 | | Formula 2 | | Formula 2 | |
| | | Layer2: | | Layer2: | | Layer2: | |
| | | YC.757 | Difference as | YC.757 | Difference as | YC.757 | Difference as |
| | LABCH | Layer3: | compared to | Layer3: | compared to | Layer3: | compared to |
| | Values | YC.165 | Standard | YC.165 | Standard | YC.165 | Standard |
| AS Such | L | 51.05 | −3.93 | 47.5 | −0.38 | 48.14 | −1.02 |
| | A | 60.42 | −0.25 | 58.84 | 1.33 | 60.55 | −0.38 |
| | B | −12.82 | 4.42 | −11.09 | 2.69 | −10.44 | 2.04 |
| | C | 61.77 | −1.01 | 59.87 | 0.89 | 61.44 | −0.68 |
| | H | 348.02 | 4.03 | 349.33 | 2.72 | 350.22 | 1.83 |
| 24 hrs 90 | L | 49.67 | −0.78 | 47.98 | 0.91 | 47.88 | 1.01 |
| Deg C. | A | 59.12 | 2.73 | 58.56 | 3.29 | 59.24 | 2.61 |
| | B | −9.06 | −0.99 | −10.61 | 0.56 | −8.27 | −1.78 |
| | C | 59.81 | 2.85 | 59.52 | 3.14 | 59.81 | 2.85 |
| | H | 351.29 | −0.52 | 349.73 | 1.04 | 352.05 | −1.28 |
| After 5 | L | 49.24 | −2.77 | 46.24 | 0.23 | 49.01 | −2.54 |
| Wash @ | A | 56.86 | 0.74 | 55.22 | 2.38 | 58.68 | −1.08 |
| 60 | B | −11.76 | 2.6 | −10.78 | 1.62 | −12.62 | 3.46 |
| Deg C./60 | C | 58.07 | 0.25 | 56.26 | 2.06 | 60.02 | −1.7 |
| Minutes | H | 348.31 | 2.65 | 348.96 | 2 | 347.87 | 3.09 |

TABLE 5

| | | | W/O Dye Blocker | | | | Formula 1, YC.077 | |
|---|---|---|---|---|---|---|---|---|
| | | Garment | | | | | | |
| | | White | | | | | 100% Black Polyester | |
| | | taken as | 100% Black | | 60:40 | | Layer1: | |
| | | Standard | Polyester | | Polyester Blend | | Formula 1 | |
| | | Layer1: | Layer1: | | Layer1: | | Layer2: | |
| | | YC.757 | YC.757 | Difference as | YC.757 | Difference as | YC.757 | Difference as |
| | LABCH | Layer2: | Layer2: | compared to | Layer2: | compared to | Layer3: | compared to |
| | Values | YC.077 | YC.077 | Standard | YC.077 | Standard | YC.077 | Standard |
| AS Such | L | 100.98 | 45.25 | 55.73 | 62.54 | 38.44 | 100.98 | 0 |
| | A | −37.37 | −14.65 | −22.72 | −25.17 | −12.2 | −40.03 | 2.66 |
| | B | 76.15 | 27.82 | 48.33 | 47.94 | 28.21 | 85.1 | −8.95 |
| | C | 84.82 | 31.44 | 53.38 | 54.15 | 30.67 | 94.04 | −9.22 |
| | H | 116.14 | 117.77 | −1.63 | 117.7 | −1.56 | 115.19 | 0.95 |
| 24 hrs 90 | L | 100.94 | | | | | 98.04 | 2.9 |
| Deg C. | A | −36.44 | | | | | −37.98 | 1.54 |
| | B | 73.36 | | | | | 80.54 | −7.18 |
| | C | 81.91 | | | | | 89.04 | −7.13 |
| | H | 116.42 | | | | | 115.25 | 1.17 |
| After 5 | L | 96.06 | | | | | 94.59 | 1.47 |
| Wash @ | A | −30.87 | | | | | −33.15 | 2.28 |
| 60 | B | 59.84 | | | | | 71.4 | −11.56 |
| Deg C./60 | C | 67.33 | | | | | 78.72 | −11.39 |
| Minutes | H | 117.28 | | | | | 114.91 | 2.37 |

| | | Formula 1, YC.077 | | Formula 2, YC.077 | | | |
|---|---|---|---|---|---|---|---|
| | | Garment | | | | | |
| | | 60:40 | | 100% Black | | 60:40 | |
| | | Polyester Blend | | Polyester | | Polyester Blend | |
| | | Layer1: | | Layer1: | | Layer1: | |
| | | Formula 1 | | Formula 2 | | Formula 2 | |
| | | Layer2: | | Layer2: | | Layer2: | |
| | | YC.757 | Difference as | YC.757 | Difference as | YC.757 | Difference as |
| | LABCH | Layer3: | compared to | Layer3: | compared to | Layer3: | compared to |
| | Values | YC.077 | Standard | YC.077 | Standard | YC.077 | Standard |
| AS Such | L | 100.63 | 0.35 | 98.88 | 2.1 | 98.94 | 2.04 |
| | A | −39.34 | 1.97 | −38.68 | 1.31 | −38.53 | 1.16 |
| | B | 85.55 | −9.4 | 83.5 | −7.35 | 83.99 | −7.84 |
| | C | 94.16 | −9.34 | 92.08 | −7.26 | 92.41 | −7.59 |
| | H | 114.7 | 1.44 | 114.86 | 1.28 | 114.64 | 1.5 |
| 24 hrs 90 | L | 96.06 | 4.88 | 89.28 | 11.66 | 95.75 | 5.19 |
| Deg C. | A | −31.84 | −4.6 | −25.81 | −10.63 | −33.73 | −2.71 |
| | B | 72.97 | 0.39 | 55.51 | 17.85 | 73.87 | −0.51 |
| | C | 79.62 | 2.29 | 61.22 | 20.69 | 81.2 | 0.71 |
| | H | 113.57 | 2.85 | 114.94 | 1.48 | 114.55 | 1.87 |
| After 5 | L | 92.04 | 4.02 | 88.91 | 7.15 | 92.33 | 3.73 |
| Wash @ | A | −28.15 | −2.72 | −28.5 | −2.37 | −29.89 | −0.98 |
| 60 | B | 66.5 | −6.66 | 63.86 | −4.02 | 68.73 | −8.89 |
| Deg C./60 | C | 72.21 | −4.88 | 69.94 | −2.61 | 74.94 | −7.61 |
| Minutes | H | 112.95 | 4.33 | 114.05 | 3.23 | 113.5 | 3.78 |

TABLE 6

| | | | W/O Dye Blocker | | | | Formula 1, YC.119 | |
|---|---|---|---|---|---|---|---|---|
| | | Garment | | | | | | |
| | | White | | | | | 100% Black Polyester | |
| | | taken as | 100% Black | | 60:40 | | Layer1: | |
| | | Standard | Polyester | | Polyester Blend | | Formula 1 | |
| | | Layer1: | Layer1: | | Layer1: | | Layer2: | |
| | | YC.757 | YC.757 | Difference as | YC.757 | Difference as | YC.757 | Difference as |
| | LABCH | Layer2: | Layer2: | compared to | Layer2: | compared to | Layer3: | compared to |
| | Values | YC.119 | YC.119 | Standard | YC.119 | Standard | YC.119 | Standard |
| AS Such | L | 83.36 | 38.05 | 45.31 | 51.84 | 31.52 | 81.67 | 1.69 |
| | A | 61.91 | 9.35 | 52.56 | 29.97 | 31.94 | 66.41 | −4.5 |
| | B | 62.37 | 6.47 | 55.9 | 29.89 | 32.48 | 66.7 | −4.33 |
| | C | 87.88 | 11.37 | 76.51 | 42.32 | 45.56 | 94.12 | −6.24 |
| | H | 45.22 | 34.68 | 10.54 | 44.92 | 0.3 | 45.12 | 0.1 |
| 24 hrs 90 | L | 84.81 | | | | | 79.35 | 5.46 |
| Deg C. | A | 57.14 | | | | | 62.66 | −5.52 |
| | B | 59.23 | | | | | 60.67 | −1.44 |
| | C | 82.3 | | | | | 87.22 | −4.92 |
| | H | 46.03 | | | | | 44.07 | 1.96 |
| After 5 | L | 80.08 | | | | | 76.97 | 3.11 |
| Wash @ | A | 52.07 | | | | | 56.62 | −4.55 |
| 60 | B | 49.87 | | | | | 50.65 | −0.78 |
| Deg C./60 | C | 72.1 | | | | | 75.97 | −3.87 |
| Minutes | H | 43.76 | | | | | 41.81 | 1.95 |

| | | Formula 1, YC.119 | | Formula 2, YC.119 | | | |
|---|---|---|---|---|---|---|---|
| | | Garment | | | | | |
| | | 60:40 | | 100% Black | | 60:40 | |
| | | Polyester Blend | | Polyester | | Polyester Blend | |
| | | Layer1: | | Layer1: | | Layer1: | |
| | | Formula 1 | | Formula 2 | | Formula 2 | |
| | | Layer2: | | Layer2: | | Layer2: | |
| | | YC.757 | Difference as | YC.757 | Difference as | YC.757 | Difference as |
| | LABCH | Layer3: | compared to | Layer3: | compared to | Layer3: | compared to |
| | Values | YC.119 | Standard | YC.119 | Standard | YC.119 | Standard |
| AS Such | L | 81.38 | 1.98 | 80.19 | 3.17 | 81.8 | 1.56 |
| | A | 58.28 | 3.63 | 65.44 | −3.53 | 58.32 | 3.59 |
| | B | 57.87 | 4.5 | 63.76 | −1.39 | 57.97 | 4.4 |
| | C | 82.13 | 5.75 | 91.37 | −3.49 | 82.22 | 5.66 |
| | H | 44.8 | 0.42 | 44.25 | 0.97 | 44.83 | 0.39 |
| 24 hrs 90 | L | 79.65 | 5.16 | 74.3 | 10.51 | 80.01 | 4.8 |
| Deg C. | A | 56.29 | 0.85 | 56.83 | 0.31 | 53.81 | 3.33 |
| | B | 54.16 | 5.07 | 51.06 | 8.17 | 50.56 | 8.67 |
| | C | 78.11 | 4.19 | 76.4 | 5.9 | 73.84 | 8.46 |
| | H | 43.9 | 2.13 | 41.94 | 4.09 | 43.22 | 2.81 |
| After 5 | L | 74.74 | 5.34 | 73.87 | 6.21 | 77.28 | 2.8 |
| Wash @ | A | 45.8 | 6.27 | 55.25 | −3.18 | 52.63 | −0.56 |
| 60 | B | 38.8 | 11.07 | 46.56 | 3.31 | 45.97 | 3.9 |
| Deg C./60 | C | 60.03 | 12.07 | 75.25 | −3.15 | 69.88 | 2.22 |
| Minutes | H | 40.28 | 3.48 | 40.12 | 3.64 | 41.13 | 2.63 |

As illustrated in the Tables 1 to 6, a lower value of L was observed for the prints on 100% polyester and 60:40 (polyester:cotton) without the dye blocking ink. The lower L values result from the bleeding of the polyester dye on to the top layer of the color print and turning the top color a darker shade.

The higher L values obtained using the dye blocking printing ink of the present disclosure shows that the polyester dye has not bled on to the top layer of the color print for the 100% black polyester and 60:40 (polyester:cotton) blend fabrics.

### Technical Advances and Economic Significance

The present disclosure provides a dye blocking printing ink system for printing on polyester blended and 100% polyester fabrics.
The present disclosure also provides a dye blocking printing ink which stops the migration of dye from the fabric to the print.
The dye blocking printing ink of the present disclosure is also formaldehyde free and hence, environment friendly.

The exemplary embodiments herein quantify the benefits arising out of this disclosure and the various features and advantageous details thereof are explained with reference to the non-limiting embodiments in the description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

1. A dye blocking printing ink comprising:
a. a resin devoid of vinyl chloride moiety in an amount ranging from 15 to 45 wt %;
b. a plasticizer in an amount ranging from 20 to 55 wt %;
c. an organic wetting agent in an amount ranging from 5 to 35 wt %; and
d. a formaldehyde free discharge agent in an amount ranging from 2 to 30 wt %.

2. The dye blocking printing ink of claim 1, wherein said resin devoid of vinyl chloride moiety is at least one selected from the group comprising acrylic resins, silicones, polyurethanes, polyesters and epoxies.

3. The plasticizer as claimed in claim 1, wherein said plasticizer is a polymeric, low solvating plasticizer, preferably a polyester adipate.

4. The plasticizer as claimed in claim 1, wherein said plasticizer is a non-polymeric, high solvating plasticizer, preferably a benzoic acid diester.

5. The dye blocking printing ink of claim 1, wherein said wetting agent is at least one organic solvent selected from the group comprising white spirit and mineral turpentine.

6. The dye blocking printing ink of claim 1, wherein said discharge agent has a structure of Formula I: 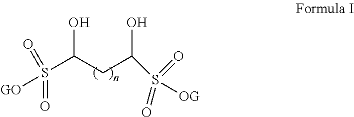
wherein G represents a group 1 metal; and n is 1 to 6.

7. The dye blocking printing ink of claim 1, wherein discharge agent said is an organic sulfur compound comprising at least one oxide of sulfur residue.

8. The dye blocking printing ink of claim 1 further comprises an extender selected from the group comprising zeolite and activated carbon, in an amount ranging from 3 to 40 wt %.

9. A process for printing a dyed fabric using said dye blocking printing ink of claim 1, said process comprising the following steps:
a. applying at least two strokes of said dye blocking printing ink on said fabric and flash during the print at a temperature ranging from 90 to 110° C. for a time period ranging from 2 to 6 seconds;
b. optionally applying at least strokes of a white ink over the said flash cured dye blocking printing ink and flash curing at a temperature ranging from 90 to 100° C. for a time period ranging from 2 to 6 seconds; and
c. applying a final layer of color dye over said white ink with a color printing ink and curing the color print at a temperature ranging from 140 to 180° C. for a time period ranging from 60 to 120 seconds.

10. The process of claim 9, wherein the process further comprises of mixing said dye blocking print with Sera Con P-ACT in a ratio of 100:10 to obtain a homogenous mixture, prior to applying on the dyed fabric.

11. The process of claim 9, wherein the prints are allowed to dry before applying the next layer.
